(19) United States
(12) Patent Application Publication
(10) Pub. No.: US 2020/0355650 A1
(43) Pub. Date: Nov. 12, 2020

(54) CHROMATOGRAPH DATA PROCESSOR AND AUTOMATIC SAMPLE INJECTOR

(71) Applicant: SHIMADZU CORPORATION, Kyoto-shi (JP)

(72) Inventors: Yasuhiro KIMOTO, Kyoto-shi (JP); Gregory KING, Kyoto-shi (JP)

(73) Assignee: SHIMADZU CORPORATION, Kyoto-shi (JP)

(21) Appl. No.: 16/750,377

(22) Filed: Jan. 23, 2020

(30) Foreign Application Priority Data
May 8, 2019 (JP) 2019-088564

(51) Int. Cl. G01N 30/24; G01N 30/62; G01N 35/00

(52) U.S. Cl. CPC G01N 30/24; G01N 30/62; G01N 2035/00841; G01N 2035/00801; G01N 2035/00831; G01N 35/00732

(57) ABSTRACT

Pre-registration information representing a correspondence relationship between analysis information representing a condition in regards to analysis or preparation of a sample, and a tray ID or a container type ID of a sample container is acquired by a pre-registration information acquirer. The tray ID or the container type ID is acquired by a tray ID acquirer or a container type ID acquirer from an automatic sample injector. The analysis information corresponding to the tray ID or the container type ID is specified by an analysis information specifier based on pre-registration information. Holding information representing whether a sample is held in a tray is acquired by a holding information acquirer from the automatic sample injector. A batch file is created by a batch file creator based on the holding information and the analysis information.

### BACKGROUND OF THE INVENTION

### Field of the Invention

The present invention relates to a chromatograph data processor and an automatic sample injector.

### Description of Related Art

Chromatographs have been known as analysis devices that separate substances included in samples into different components. In an analysis system, a plurality of samples are introduced into a chromatograph sequentially by an automatic sample injector, and the samples are analyzed. Therefore, a batch file for controlling the analysis sequence of the samples is generally created. The automatic sample injector and the chromatograph are controlled based on the created batch file.

A batch file is a file in which the correspondence relationship between each sample, and an analysis condition or the like is described in a table format, for example. An operator can create the batch file by inputting predetermined information in a table. Here, since creating a batch file as a routine operation, the operator is required to be able to create the batch file efficiently and without errors.

For example, in the automatic analysis device described in WO 2016/189668 A1, a setting screen for a batch file is displayed in a display unit. The setting screen includes an image display area and a text display area. In the image display area, the image representing a plan view of a container holding unit of a sample is displayed. An operator can create a batch file intuitively by performing a setting operation in regards to the image display area or the text display area.

### BRIEF SUMMARY OF THE INVENTION

Using the automatic analysis device described in WO 2016/189668 A1, in a case where being skilled in handling the automatic analysis device, an operator can create a batch file efficiently. However, all operators are not necessarily skilled in handling the automatic analysis device, and it is difficult for an unskilled operator to create a batch file efficiently. Further, regardless of the level of skill of an operator, an error in the operation of creating the batch file cannot be prevented completely. An object of the present invention is to provide a chromatograph data processor and an automatic sample injector that can create a batch file efficiently and without errors.

One aspect of the present invention is a chromatograph data processor that is connected to an automatic sample injector that can introduce a sample held by any one of a plurality of sample holders of a tray into a chromatograph, comprising a pre-registration information acquirer that acquires pre-registration information representing a correspondence relationship between analysis information representing a condition in regards to analysis or preparation of the sample and a tray ID (identifier) unique to the tray, a tray ID acquirer that acquires a tray ID from the automatic sample injector, an analysis information specifier that specifies analysis information corresponding to the tray ID acquired by the tray ID acquirer based on the pre-registration information acquired by the pre-registration information acquirer, a holding information acquirer that acquires holding information representing whether a sample is held by each sample holder of the tray from the automatic sample injector, and a batch file creator that creates a batch file for controlling a sequence of analysis or preparation in regards to one or a plurality of samples held by the tray based on the holding information acquired by the holding information acquirer and the analysis information specified by the analysis information specifier.

Another aspect of the present invention is a chromatograph data processor connected to an automatic sample injector that can introduce a sample into a chromatograph from a sample container held by any one of a plurality of container holders, comprising a pre-registration information acquirer that acquires pre-registration information representing a correspondence relationship between analysis information representing a condition in regards to analysis or preparation of the sample and a container type ID (identifier) unique to a type of the sample container, a container type ID acquirer that acquires a container type ID of each sample container held by any one of the plurality of container holders from the automatic sample injector, an analysis information specifier that specifies analysis information corresponding to a container type ID of each sample container based on pre-registration information acquired by the pre-registration information acquirer, the container type ID being acquired by the container type ID acquirer, a holding information acquirer that acquires holding information representing whether a sample container is held by each container holder from the automatic sample injector, and a batch file creator that creates a batch file for controlling a sequence of analysis or preparation of a sample stored in one or a plurality of held sample containers based on the holding information acquired by the holding information acquirer and the analysis information specified by the analysis information specifier.

Yet another aspect of the present invention is an automatic sample injector that is connected to a chromatograph data processor and can introduce a sample held by any one of a plurality of sample holders of a tray into a chromatograph, comprising a tray ID notifier that notifies the chromatograph data processor of a tray ID (identifier) unique to the tray, and a holding information notifier that notifies the chromatograph data processor of holding information representing whether a sample is held by each sample holder of the tray.

Yet another aspect of the present invention is an automatic sample injector that is connected to a chromatograph data processor and can introduce a sample into a chromatograph from a sample container held by any one of a plurality of container holders, comprising a holding information notifier that notifies the chromatograph data processor of holding information representing whether a sample container is held by each container holder, and a container type ID notifier that notifies the chromatograph data processor of a container type ID (identifier) unique to a type of one or a plurality of held sample containers. Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a diagram showing the configuration of an analysis system;

FIG. 2 is a plan view showing one example of a tray;

FIG. 3 is a diagram showing the configuration of an automatic sample injector;

FIG. 4 is a diagram showing the configuration of the automatic sample injector;

FIG. 5 is a diagram showing the functional configuration of a data processor;

FIG. 6 is a diagram showing one example of pre-registration information acquired by a pre-registration information acquirer;

FIG. 7 is a diagram showing one example of the pre-registration information acquired by the pre-registration information acquirer;

FIG. 8 is a diagram showing one example of the pre-registration information acquired by the pre-registration information acquirer;

FIG. 9 is a diagram showing a tray placed in a placement unit;

FIG. 10 is a diagram showing an example of a tray ID acquired by a tray ID acquirer;

FIG. 11 is a diagram showing an example of holding information acquired by a holding information acquirer;

FIG. 12 is a diagram showing an example of a batch file created by a batch file creator;

FIG. 13 is a diagram showing one example of a display screen of a display device when the pre-registration information is created;

FIG. 14 is a flow chart showing one example of the algorithm of a notification process executed by a notification program;

FIG. 15 is a flow chart showing one example of the algorithm of a data process executed by a data processing program;

FIG. 16 is a diagram showing the configuration of an automatic sample injector according to a modified example;

FIG. 17 is a diagram showing the configuration of a data processor according to the modified example;

FIG. 18 is a diagram showing the configuration of the automatic sample injector according to the second embodiment; and

FIG. 19 is a diagram showing the configuration of a data processor according to the second embodiment.

### DESCRIPTION OF THE PREFERRED EMBODIMENTS

### 1First Embodiment

(1) Configuration of Analysis System

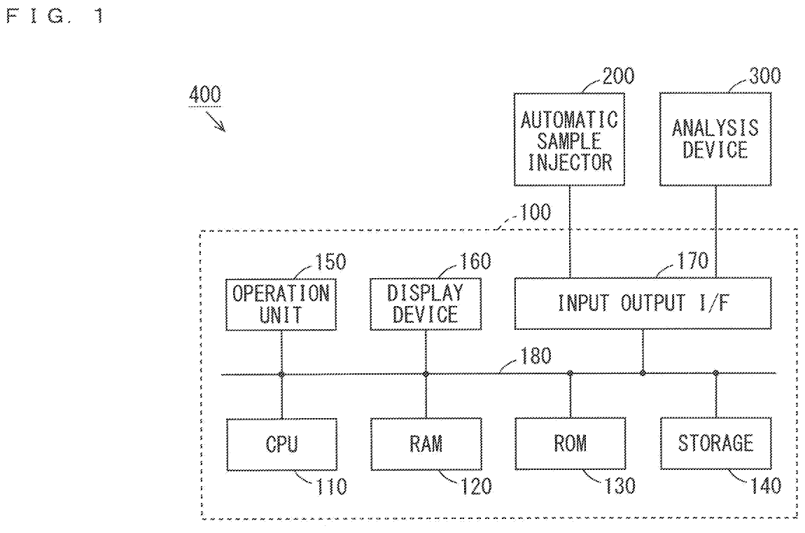

A chromatograph data processor and an automatic sample injector according to the first embodiment will be described below with reference to the drawings. FIG. 1 is a diagram showing the configuration of an analysis system. As shown in FIG. 1, an analysis system 400 includes the chromatograph data processor 100 (hereinafter abbreviated as a data processor 100), the automatic sample injector 200 and an analysis device 300.

The data processor 100 is constituted by a CPU (Central Processing Unit) 110, a RAM (Random Access Memory) 120, a ROM (Read Only Memory) 130, a storage 140, an operation unit 150, a display device 160 and an input output I/F (interface) 170 and a bus 180. The CPU 110, the RAM 120, the ROM 130, the storage 140, the operation unit 150, the display device 160 and the input output I/F 170 are connected to the bus 180.

The RAM 120 is used as a work area for the CPU 110. A system program is stored in the ROM 130. The storage 140 includes a storage medium such as a hard disc or a semiconductor memory, and stores a data processing program and pre-registration information mentioned below. The data processing program and the pre-registration information may be stored in a storage medium different from the storage 140.

The CPU 110 executes the data processing program stored in the storage 140 or the like on the RAM 120, whereby a data process is executed. The data process is the process of automatically creating a batch file for controlling a sequence of analysis or preparation (a pre-process) of a plurality of samples and controlling operations of the automatic sample injector 200 and the analysis device 300 based on the created batch file. Details of the data process will be described below.

The operation unit 150 is an input device such as a keyboard, a mouse or a touch panel. The display device 160 is a liquid crystal display device or the like. A user of the analysis system 400 can provide various instructions to the data processor 100 using the operation unit 150. The display device 160 can display a batch file created by the data processor 100, a result of analysis by the analysis device 300 or the like. The input output I/F 170 is connected to the automatic sample injector 200 and the analysis device 300.

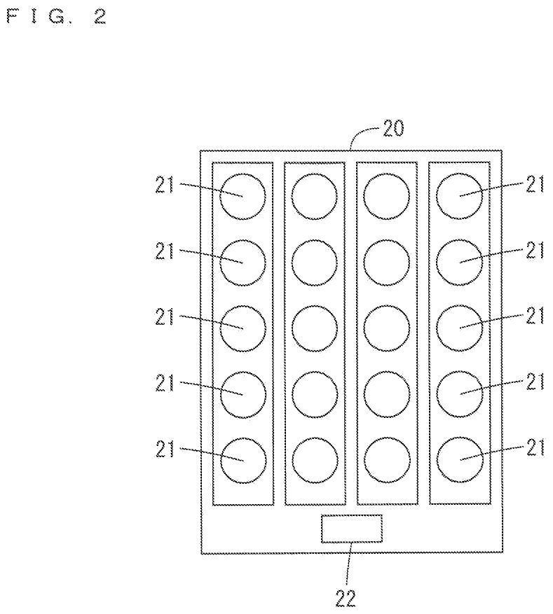

One or a plurality of trays provided with unique IDs (identifiers) are placed in the automatic sample injector 200. FIG. 2 is a plan view showing one example of a tray. As shown in FIG. 2, a plurality of container holders 21 and a tray ID display 22 are formed in the tray 20. The container holders 21 are an example of a sample holder. In the example of FIG. 2, twenty container holders 21 that are arranged in 5 rows and 4 columns are formed in the tray 20.

The tray ID display 22 shows an ID (hereinafter referred to as a tray ID) that is an RF (Radio Frequency) ID tag, a barcode or a QR code (trademark), for example, and provided to the tray 20. The tray ID display 22 may be n magnets (n is an integer that is 1 or larger than 1) and show a tray ID by a binary code. In this case, the tray ID display 22 can show the tray IDs in 2ⁿ ways.

Further, in the present embodiment, necessary various information (hereinafter referred to as analysis information) in regards to analysis or preparation of a sample is predetermined for each tray 20. Specifically, the analysis information includes an analysis method including an analysis condition or an examination condition, a preparation condition, a sample type, a sample injection amount, a below-mentioned analysis line of the analysis device 300, an output format of an analysis result or the like. The sample type is classified into a standard sample, an unknown sample or a control sample, for example. Further, the analysis information includes the concentration of a standard sample.

The correspondence relationship between the analysis information and a tray ID of each tray 20 is stored (registered) in the storage 140 in advance as the pre-registration information. The pre-registration information is registered by a technician such as a field engineer when the automatic sample injector 200 is installed or an analysis protocol is formulated, for example. A batch file is created with use of the registered pre-registration information. The user can also change the pre-registration information when preparing the analysis protocol such as the time when changing the sample injection amount.

The user of the analysis system 400 selects the tray 20 fitted to the desired analysis information as a tray 20 to be used for analysis. A comment field, a numbered tag or the like may be added to each tray 20 such that the tray fitted to the desired analysis information can be easily identified. Alternatively, a plurality of trays 20 having different colors may be used.

The user causes appropriate container holders 21 of the tray 20 to hold sample containers (vials) in which appropriate samples are stored according to the analysis information corresponding to the selected tray 20. Thereafter, the user places the tray 20 in the automatic sample injector 200. Thus, the automatic sample injector 200 sucks the samples sequentially from the sample containers of the tray 20 according to the batch file created by the data processor 100, and introduces the samples to the analysis device 300. Details of the automatic sample injector 200 will be described below.

The analysis device 300 is an example of a chromatograph and sequentially analyzes the samples introduced by the automatic sample injector 200 according to the batch file created by the data processor 100. While the analysis device 300 is a gas chromatograph in the present embodiment, the analysis device 300 may be a liquid chromatograph. Further, in the present embodiment, the analysis device 300 has a plurality of analyzers (analysis lines) and can analyze a sample in each of the plurality of analysis lines.

(2) Automatic Sample Injection Device

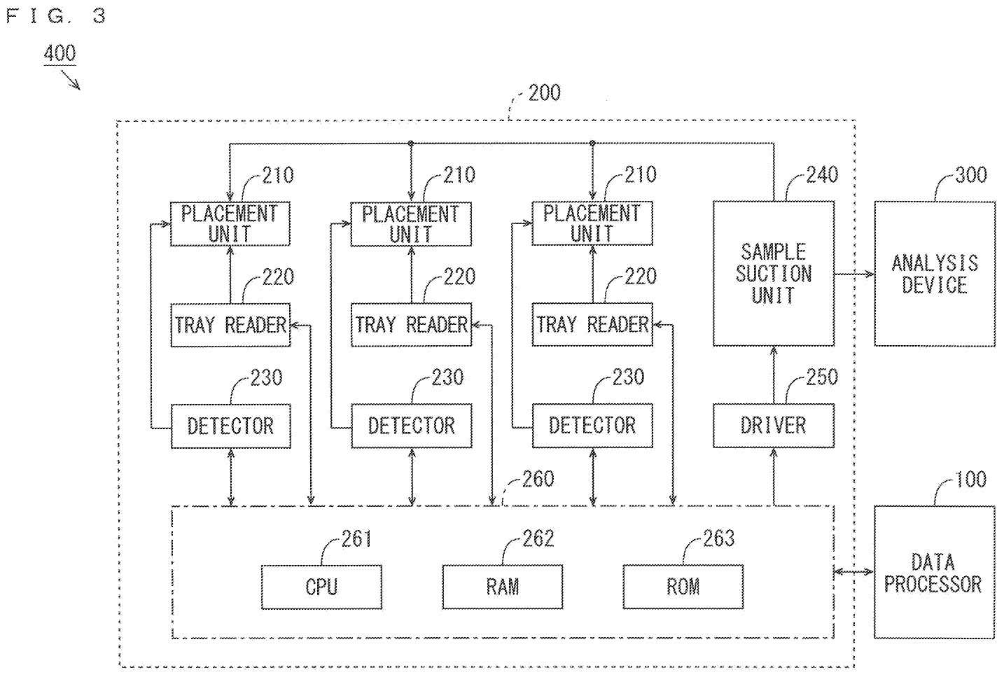

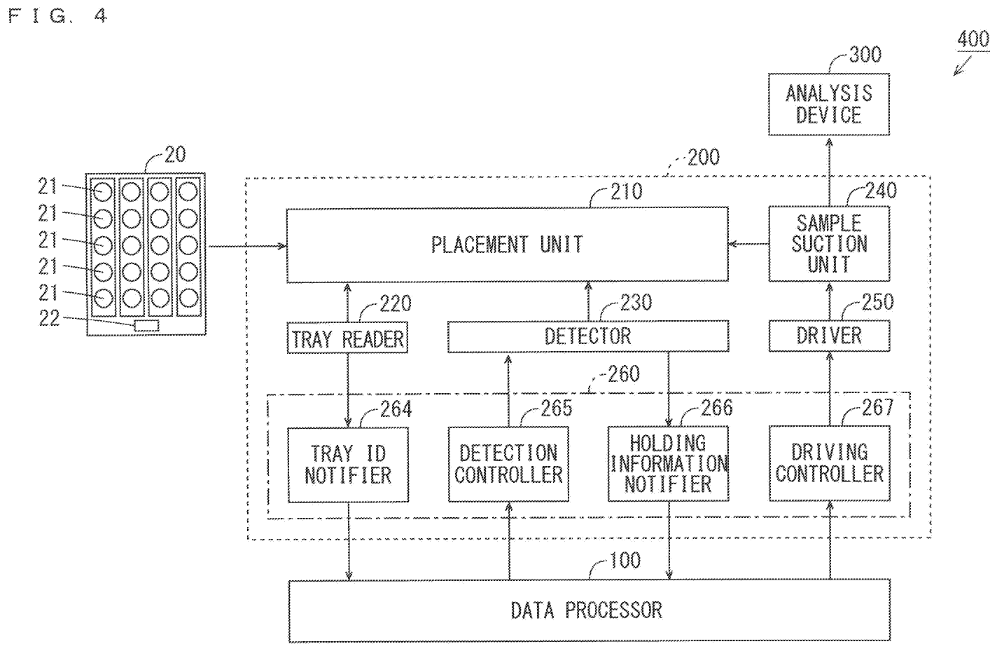

FIGS. 3 and 4 are diagrams showing the configuration of the automatic sample injector 200. The configuration of hardware of the automatic sample injector 200 is shown in FIG. 3, and the functional configuration of the automatic sample injector 200 is shown in part of FIG. 4. As shown in FIGS. 3 and 4, the automatic sample injector 200 includes a plurality of placement units 210, a plurality of tray readers 220, a plurality of detectors 230, a sample suction unit 240, a driver 250 and a control device 260.

While the plurality of tray readers 220 and the plurality of detectors 230 are provided to respectively correspond to the plurality (three in the present example) of placement units 210 in the present embodiment, the embodiment is not limited to this. One tray reader 220 that can access the plurality of placement units 210 may be provided, or one detector 230 that can access the plurality of placement units 210 may be provided. In FIG. 4, one tray reader 220 and one detector 230 are shown, and the other tray readers 220 and the other detectors 230 are not shown.

A tray 20 can be placed in each placement unit 210. A tray reader 220 is an RFID reader, a barcode reader or a QR code reader, for example. In a case where a tray ID display 22 is a magnet, the tray reader 220 may be a magnet sensor. The tray reader 220 reads a tray ID from a tray ID display 22 of a tray 20 placed in a corresponding placement unit 210, and supplies the read tray ID to the control device 260.

A detector 230 detects whether a sample container is held by each container holder 21 of the tray 20 placed in a corresponding placement unit 210, and supplies the holding information representing whether a sample container is held by each container holder 21 of the tray 20 to the control device 260. In the present example, the detector 230 is a scanner, and detects whether a sample container is held by each container holder 21 by scanning the tray 20. The scanner may include a reflective-type photo sensor or a transmission type photo sensor, and may be a contact sensor that detects presence or absence of a sample container by physical contact with a sample container. The embodiment is not limited to this, and the detector 230 may be a gas sensor or the like.

The sample suction unit 240 includes a syringe, a holder of the syringe and a holder of a tray 20, etc. The driver 250 includes a plurality of actuators. The actuator may include a stepping motor, for example. The driver 250 introduces a sample into the analysis device 300 from a sample container held by a container holder 21 of the tray 20 by driving the sample suction unit 240 and a tray 20.

Specifically, a sample vaporization chamber of the analysis device 300 is arranged below the syringe of the sample suction unit 240. The driver 250 is configured to be capable of moving the syringe between a predetermined reference position and a position below the predetermined reference position. Further, the driver 250 is configured to be capable of moving the tray 20 between a placement unit 210 and a suction position below the reference position and above the sample vaporization chamber.

The tray 20 is moved to the suction position, and then the syringe is moved from the reference position to the suction position below the reference position. Thus, the needle of the syringe is inserted into a sample container held by a predetermined container holder 21 of the tray 20. The plunger of the syringe is driven in this state, so that a sample is sucked by the syringe. Further, the tray 20 is retracted from the suction position, and then the syringe is moved to a position below the suction position. Thus, the needle of the syringe is inserted into the sample vaporization chamber. The plunger of the syringe is driven in this state, so that the sample is introduced into the sample vaporization chamber.

As shown in FIG. 3, the control device 260 is constituted by a CPU 261, a RAM 262 and a ROM 263. As shown in FIG. 4, the control device 260 includes a tray ID notifier 264, a detection controller 265, a holding information notifier 266 and a driving controller 267 as functions. The CPU 261 executes an application program such as a notification program stored in the ROM 263 on the RAM 262, whereby the functions of the control device 260 are realized and a notification process, described below, is executed. Part or all of the functions of the control device 260 may be realized by hardware such as an electronic circuit.

The tray ID notifier 264 acquires a tray ID from each tray reader 220, and notifies the data processor 100 of the tray ID. In response to an instruction provided by the user, the detection controller 265 controls the detector 230 such that the detector 230 detects whether a sample container is held by each container holder 21 of each tray 20.

The user can instruct the detection controller 265 to start detection by operating a predetermined button provided in the data processor 100 or the automatic sample injector 200. The button for providing an instruction for starting detection may include a button on a graphical user interface.

The holding information notifier 266 acquires the holding information from each detector 230 and notifies the data processor 100 of the holding information. The driving controller 267 controls the driver 250 such that a sample is introduced into the analysis device 300. The tray ID notifier 264, the detection controller 265 and the holding information notifier 266, described above, operate when a notification process, described below, is executed. On the other hand, the driving controller 267 operates when a sample is analyzed or prepared.

(3) Configuration of Data Processor

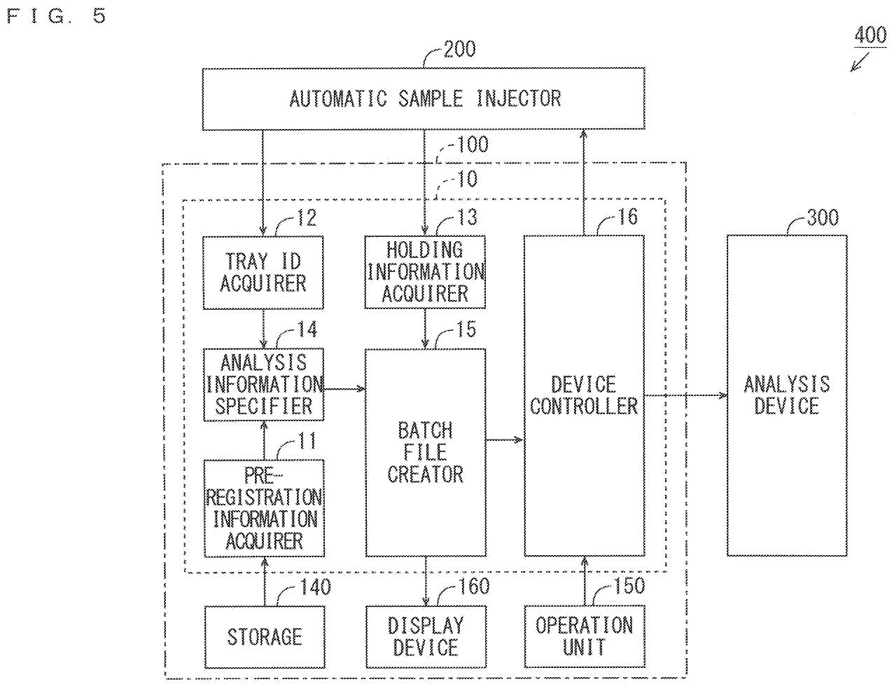

FIG. 5 is a diagram showing the functional configuration of the data processor 100. As shown in FIG. 5, the data processor 100 includes a pre-registration information acquirer 11, a tray ID acquirer 12, a holding information acquirer 13, an analysis information specifier 14, a batch file creator 15 and a device controller 16 as a function 10. The CPU 110 of FIG. 1 executes the data processing program stored in the storage 140 or the like, whereby the functions 10 are realized. Part or all of the functions 10 may be realized by hardware such as an electronic circuit.

The pre-registration information acquirer 11 acquires the pre-registration information registered in the storage 140. In a case where the pre-registration information is registered in a storage medium different from the storage 140, the pre-registration information acquirer 11 acquires the pre-registration information from the storage medium. Further, in a case where the tray 20 of FIG. 2 includes a storage element, the pre-registration information corresponding to each tray 20 may be registered in a storage element of the tray 20. In this case, the pre-registration information acquirer 11 acquires the pre-registration information from a storage element of each tray 20.

The tray ID acquirer 12 acquires a tray ID from the automatic sample injector 200. The holding information acquirer 13 acquires the holding information from the automatic sample injector 200. The analysis information specifier 14 specifies the analysis information corresponding to the tray ID acquired by the tray ID acquirer 12 based on the pre-registration information acquired by the pre-registration information acquirer 11.

The batch file creator 15 creates a batch file for controlling the analysis of the samples stored in all of the held sample containers based on the holding information acquired by the holding information acquirer 13 and the analysis information specified by the analysis information specifier 14. Based on the batch file created by the batch file creator 15, the device controller 16 controls the automatic sample injector 200 or the analysis device 300 such that the samples are analyzed or prepared.

(4) Steps of Creating Batch File

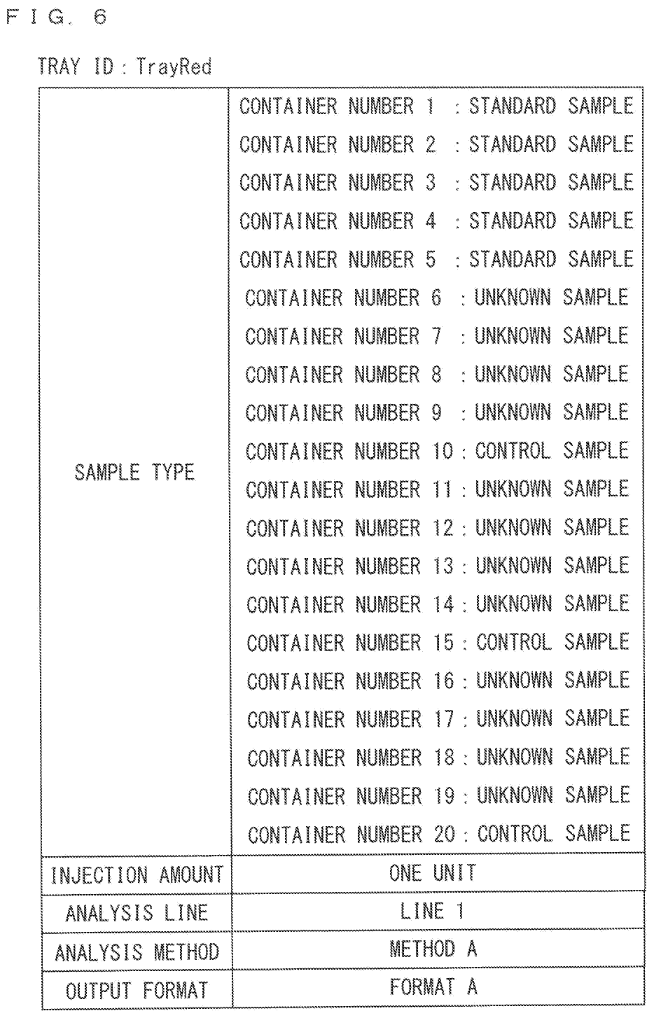

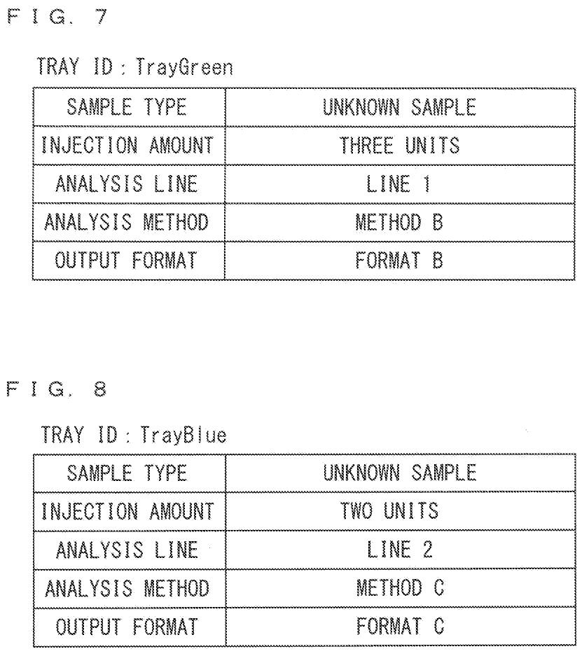

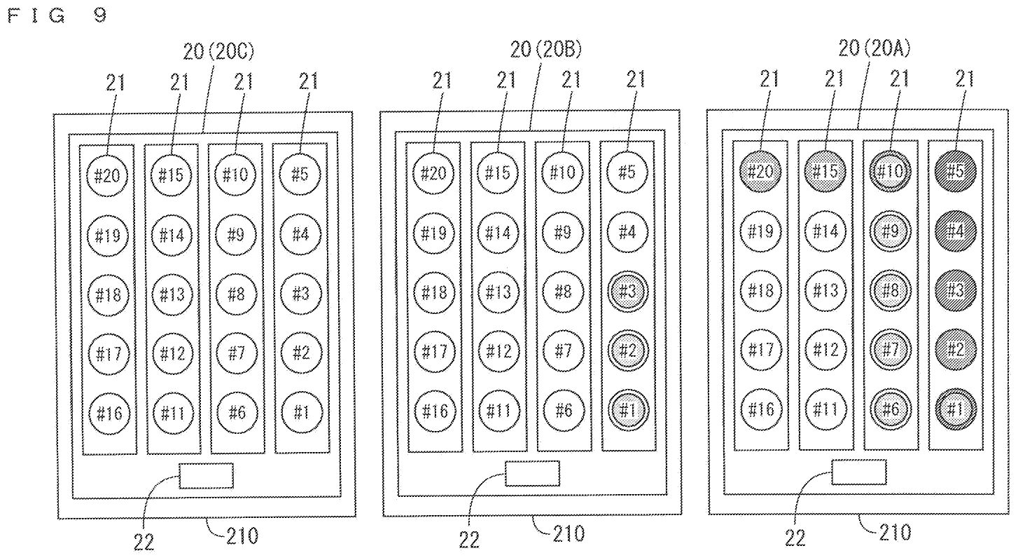

The steps of creating a batch file will be described below. FIGS. 6 to 8 are diagrams showing one example of the pre-registration information acquired by the pre-registration information acquirer 11. Specifically, FIG. 6 shows the pre-registration information in regards to the tray 20 provided with the tray ID “TrayRed.” FIG. 7 shows the pre-registration information in regards to the tray 20 provided with the tray ID “TrayGreen.” FIG. 8 shows the pre-registration information in regards to the tray 20 provided with the tray ID “TrayBlue.”

In regards to the tray 20 of FIG. 6, it is determined that standard samples are held by the container holders 21 of the “container number 1” to “container number 5.” It is determined that unknown samples are held by the container holders 21 of the “container number 6” to “container number 9,” the “container number 11” to “container number 14” and the “container number 16” to “container number 19.” It is determined that control samples are held by the container holders 21 of the “container number 10,” “container number 15” and “container number 20.” Further, the sample injection amount is one unit, the analysis line is a “line 1,” the analysis method is a “method A” and the output format of the analysis result is a “format A.”

In regards to the tray 20 of FIG. 7, it is determined that unknown samples are held by all of the container holders 21. Further, the sample injection amount is three units, and the analysis line is a “line 1,” the analysis method is a “method B,” and the output format of the analysis result is a “format B.” In regards to the tray 20 of FIG. 8, it is determined that unknown samples are held by all of the container holders 21. Further, it is determined that the sample injection amount is two units, the analysis line is a “line 2,” the analysis method is a “method C,” and the output format of the analysis result is a “format C.”

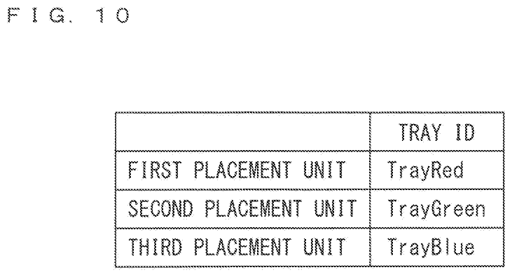

As described above, the user of the analysis system 400 selects a tray 20 to be used for analysis, and causes an appropriate container holder 21 to hold a sample container in which an appropriate sample is stored according to the analysis information corresponding to the selected tray 20. Thereafter, the user places the tray 20 on the placement unit 210 of the automatic sample injector 200 of FIG. 3. FIG. 9 is a diagram showing the tray 20 placed in the placement unit 210. As shown in FIG. 9, three trays 20 are placed in three placement units 210 respectively in the present example. In the following description, in a case where the three trays 20 are distinguished from one another, the three trays 20 are referred to as trays 20A, 20B, 20C, respectively.

In the present example, because the tray 20A is red, “TrayRed” is provided to the tray 20A as the tray ID. Because the tray 20B is green, “TrayGreen” is provided to the tray 20B as the tray ID. Because the tray 20C is blue, “TrayBlue” is provided to the tray 20C as the tray ID. The embodiment is not limited to this, and the numbers or the like may be provided to the tray 20 regardless of the color.

In each tray 20, a container holder 21 by which a standard sample is to be held, a container holder 21 by which an unknown sample is to be held and a container holder 21 by which a control sample is to be held may be formed to have different aspects (color, for example). In this case, the user can easily identify the type of the sample to be held by each container holder 21. In the example of FIG. 9, the container holder 21 by which a standard sample is to be held is indicated by a first hatching pattern, and the container holder 21 by which a control sample is to be held is indicated by a second hatching pattern. Further, a sample container including a sample held by the container holder 21 is indicated by a dotted pattern.

In the example of FIG. 9, in regards to the tray 20A, a sample container storing a standard sample is held by the container holder 21 of the “container number 1.” A sample container storing an unknown sample is held by each of the container holders 21 of the “container number 6” to “container number 9.” A sample container storing a control sample is held by the container holder 21 of the “container number 10.” In regards to the tray 20B, a sample container storing an unknown sample is held by each of the container holders 21 of the “container number 1” to “container number 3.” In regards to the tray 20C, a sample container is not held by any of the container holders 21.

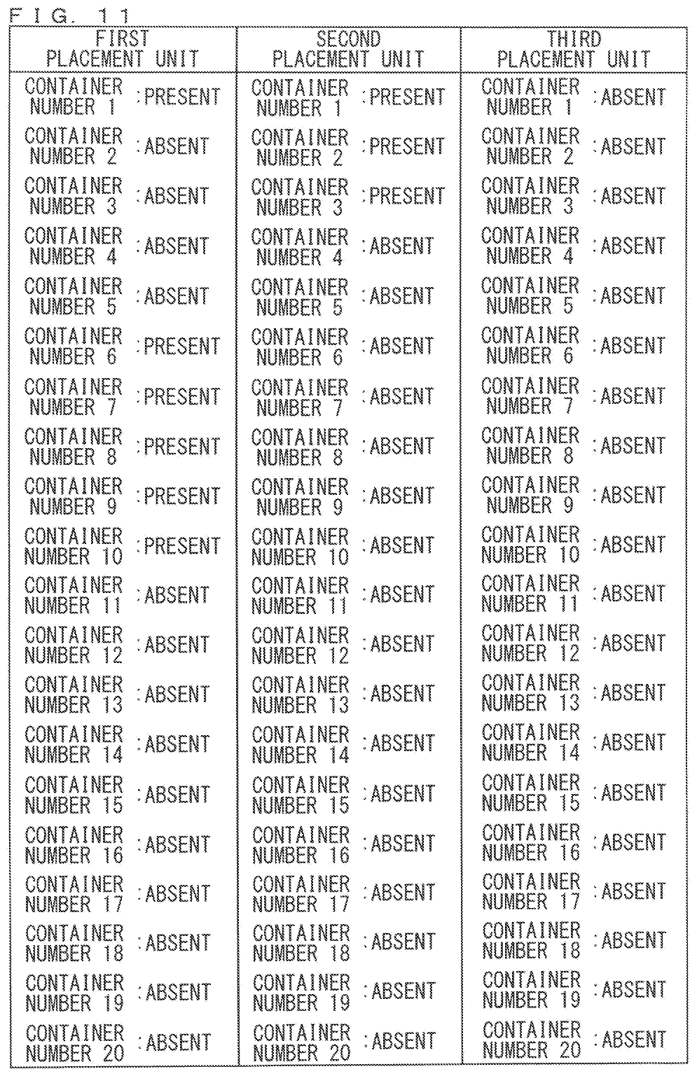

A tray ID is read by the tray reader 220 of FIG. 3 from the tray ID display 22 of each tray 20 of FIG. 9. Thus, the tray ID of each tray 20 is acquired by the tray ID acquirer 12 of FIG. 5. FIG. 10 is a diagram showing the example of the tray ID acquired by the tray ID acquirer 12. In the example of FIG. 10, the tray IDs of the trays 20 placed in the first, second and third placement units 210 are “TrayRed,” “TrayGreen,” and “TrayBlue,” respectively.

Thereafter, whether a sample container is held by each container holder 21 of each tray 20 of FIG. 9 is detected by the detector 230 of FIG. 3 in response to an instruction provided by the user. Thus, the holding information representing whether a sample container is held by each container holder 21 of each tray 20 is acquired by the holding information acquirer 13 of FIG. 5. The user can instruct the detector 230 via the device controller 16 to start detection by performing a predetermined operation using the operation unit 150 of FIG. 9.

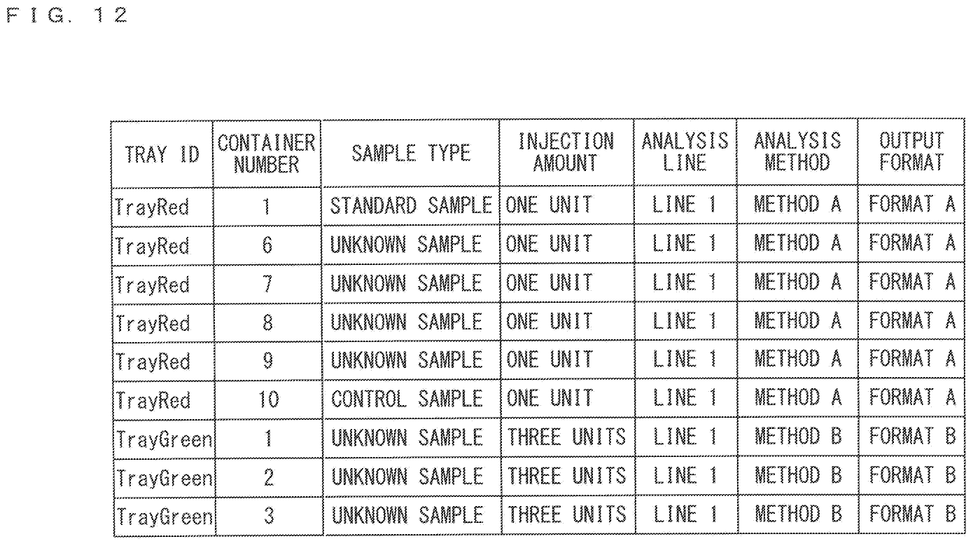

FIG. 11 is a diagram showing the example of the holding information acquired by the holding information acquirer 13. In the example of FIG. 11, in regards to the tray 20 of the first placement unit 210, a sample container is held by each of the container holders 21 of the “container number 1”, and the “container number 6” to “container number 10,” and sample containers are not held by the rest of the container holders 21. In regards to the tray 20 of the second placement unit 210, a sample container is held by each of the container holders 21 of the “container number 1” to “container number 3,” and sample containers are not held by the rest of the container holders 21. In regards to the tray 20 of the third placement unit 210, a sample container is not held by any of the container holders 21.

The analysis information specifier 14 of FIG. 5 specifies the analysis information corresponding to each tray ID by comparing the tray IDs of FIG. 10 with the tray IDs of the pre-registration information of FIGS. 6 to 8. In regards to each of the samples stored in the sample containers the holding information of which represents “PRESENT” in the FIG. 11, the batch file creator 15 of FIG. 5 creates a batch file such that the samples are sequentially analyzed or prepared according to the analysis information specified by the analysis information specifier 14.

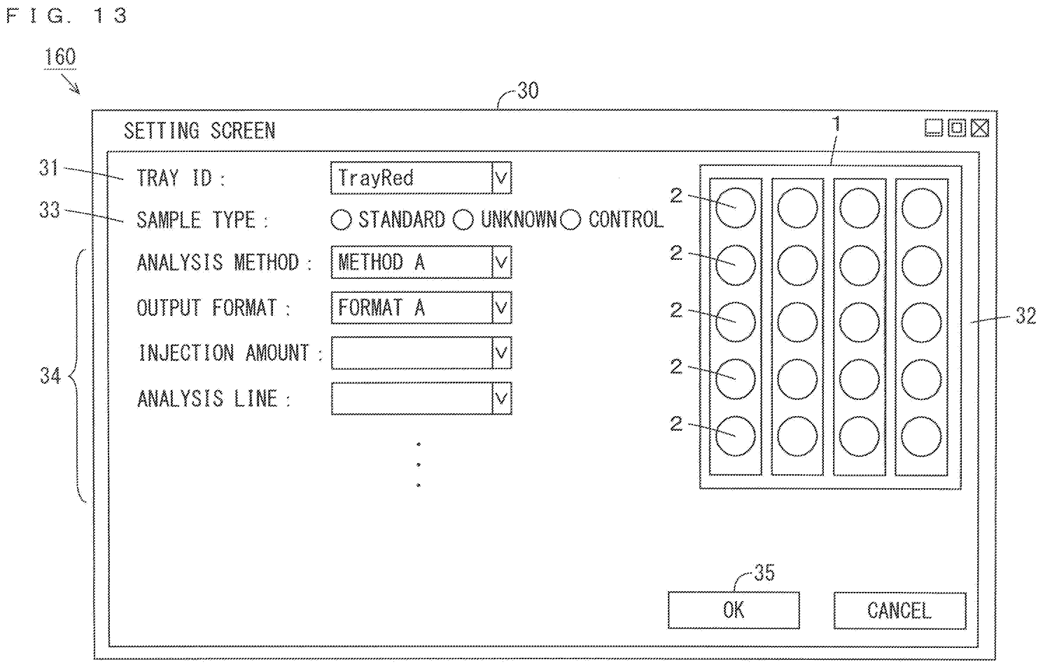

FIG. 12 is a diagram showing the example of the batch file created by the batch file creator 15. In the example of FIG. 12, in regards to the six samples held by the tray 20 (the tray 20A) the tray ID of which is “TrayRed” and the three samples held by the tray 20 (the tray 20B) the tray ID of which is “TrayGreen,” a batch file for controlling the total nine analyses is created.

In the first analysis, one unit of the standard sample held by the container holder 21 of the “container number 1” of the tray 20A is injected into the “line 1,” and the sample is analyzed by the “method A” and the result of analysis is output in the “format A.” In the second to fifth analyses, the control similar to the control carried out in the first analysis is carried out in regards to the unknown samples respectively held by the container holders 21 of the “container number 6” to “container number 9” of the tray 20A. In the sixth analysis, the control similar to the control carried out in the first analysis is carried out in regards to the control sample held by the container holder 21 of the “container number 10” of the tray 20A.

In the seventh analysis, three units of the unknown sample held by the container holder 21 of the “container number 1” of the tray 20B is injected to the “line 1,” the sample is analyzed by the “method B,” and the result of analysis is output in the “format B.” In the eighth and ninth analyses, the control similar to the control carried out in the seventh analysis is carried out in regards to the unknown samples held by the container holders 21 of the “container number 2” and “container number 3” of the tray 20B.

(5) Pre-Registration Information

As described above, the pre-registration information is created when the automatic sample injector 200 is installed or the analysis protocol is formulated, for example, and is registered in advance before the data process is executed. Although the pre-registration information is generally created by a technician different from the user of the analysis system 400, in a case where the user is skilled, the pre-registration information may be created or updated by the user. The steps of creating the pre-registration information will be described below.

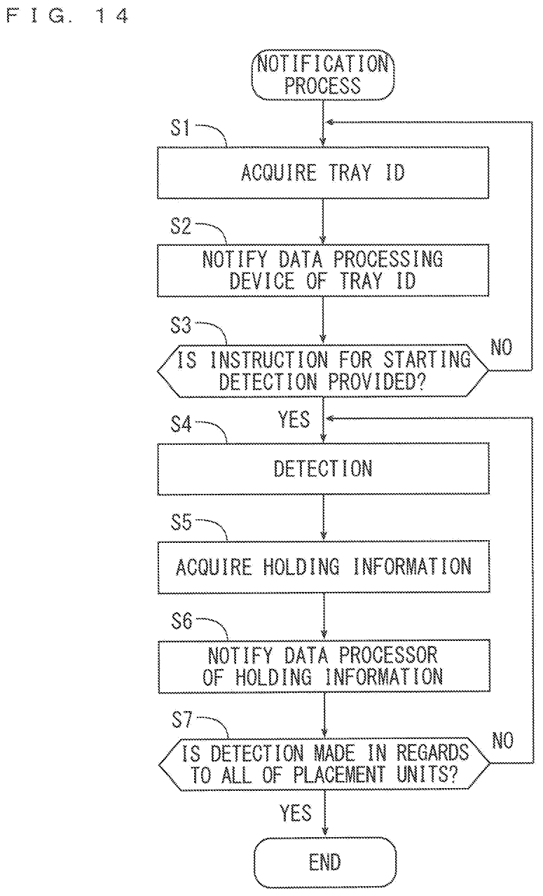

FIG. 13 is a diagram showing one example of the display screen of the display device 160 when the pre-registration information is created. As shown in FIG. 13, when the pre-registration information is created, a setting screen 30 is displayed in the display device 160. The setting screen 30 may be displayed by the function of the data processor 100, or may be displayed by the function of another information processor. The setting screen 30 includes an ID selection field 31, an image display field 32, a sample type setting field 33, an analysis information setting field 34 and an OK button 35.

In the ID selection field 31, a pull-down menu for selecting a tray ID of the tray 20 to be used by the automatic sample injector 200 is displayed. A creator of the pre-registration information can operate to select a tray ID of any tray 20 in the ID selection field 31. In the image display field 32, an imitated image 1 of the tray 20 corresponding to the tray ID selected in the ID selection field 31 is displayed. The imitated image 1 includes image portions 2 representing a plurality of container holders 21.

Check boxes for selecting a sample type are displayed in the sample type setting field 33. The creator can set the type of a sample to be held by a container holder 21 corresponding to an image portion 2 by operating to make a selection in the sample type setting field 33 with an image portion 2 of any container holder selected in the imitated image 1 being displayed in the image display field 32.

In the analysis information setting field 34, pull-down menus for setting the analysis information except for the sample type are displayed. In the example of FIG. 13, the pull-down menus for setting the analysis method, the output format, the injection amount and the analysis line are displayed in the analysis information setting field 34. In the analysis information setting field 34, a pull-down menu for setting other analysis information may further be displayed. The creator can operate to set the analysis information of the tray 20 in the analysis information setting field 34.

Finally, the creator can confirm the pre-registration information and register the confirmed pre-registration information in the storage 140 of FIG. 1 or another storage medium by pressing the OK button 35. In the above-mentioned setting screen 30, a check box or the like having the similar function may be displayed in the ID selection field 31 or the analysis information setting field 34 instead of the pull-down menus. Alternatively, in the sample type setting field 33, a pull-down menu or the like having the similar function may be displayed in the sample type setting field 33 instead of the check boxes.

(6) Notification Process

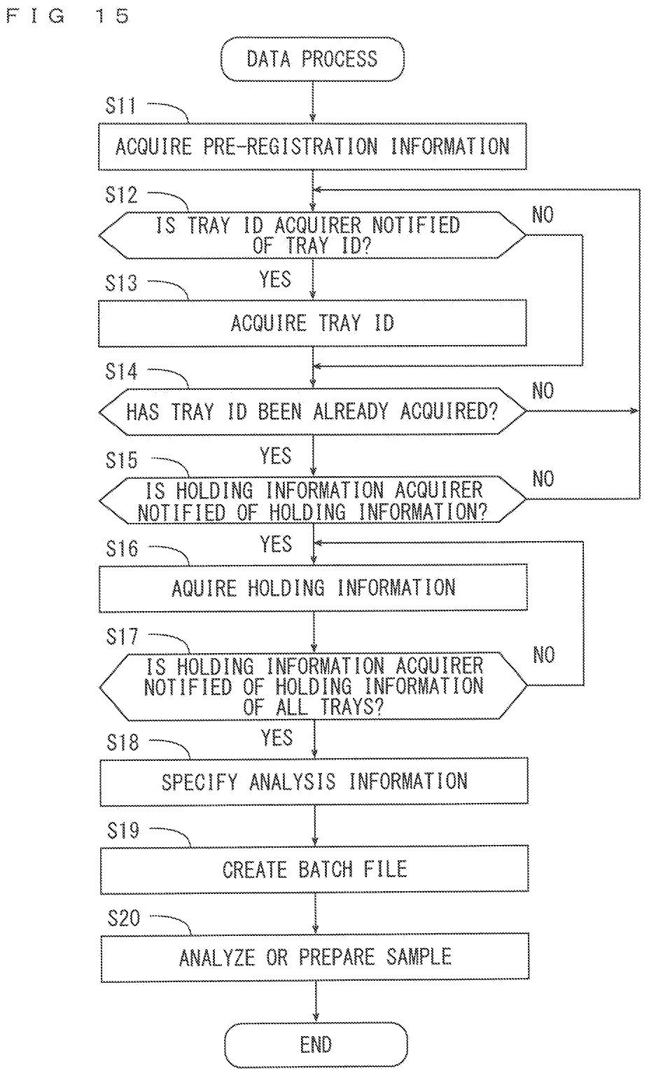

FIG. 14 is a flow chart showing one example of the algorithm of the notification process executed by the notification program. One example of the notification process will be described below with reference to the automatic sample injector 200 of FIG. 4 and the flow chart of FIG. 14.

As shown in FIG. 14, the tray ID notifier 264 acquires a tray ID from each tray reader 220 (step S1). Further, the tray ID notifier 264 notifies the data processor 100 of the tray ID acquired in the step S1 (step S2). Next, the detection controller 265 determines whether an instruction for starting detection has been provided (step S3). In a case where the instruction for starting detection is not provided, the detection controller 265 returns to the step S1. The steps S1 to S3 are repeated until the instruction for starting detection is provided.

The user can provide the instruction for starting detection by operating the data processor 100 or the automatic sample injector 200. Further, the user can change the tray 20 to be used for analysis until providing the instruction for starting detection. The step S2 may be performed at a point in time later than the step S3 in which the tray 20 to be used for analysis is confirmed.

In a case where the instruction for starting detection is provided, the detection controller 265 detects whether a sample container is held by each container holder 21 of the tray 20 placed in the placement unit 210 using the detector 230 (step S4). The holding information notifier 266 acquires the holding information detected in the step S4 from the detector 230 (step S5). Further, the holding information notifier 266 notifies the data processor 100 of the holding information acquired in the step S5 (step S6). Thereafter, the detection controller 265 determines whether detection has been made in regards to all of the placement units 210 (step S7). In a case where detection has not been made in regards to all of the placement units 210, the detection controller 265 returns to the step S4. The steps S4 to S7 are repeated until detection is made in regards to all of the placement units 210. In a case where detection is made in regards to all of the placement units 210, the detection controller 265 ends the notification process. The step S6 may be performed after the step S7 in which it is confirmed that detection is made in regards to all of the placement units 210.

(7) Data Process

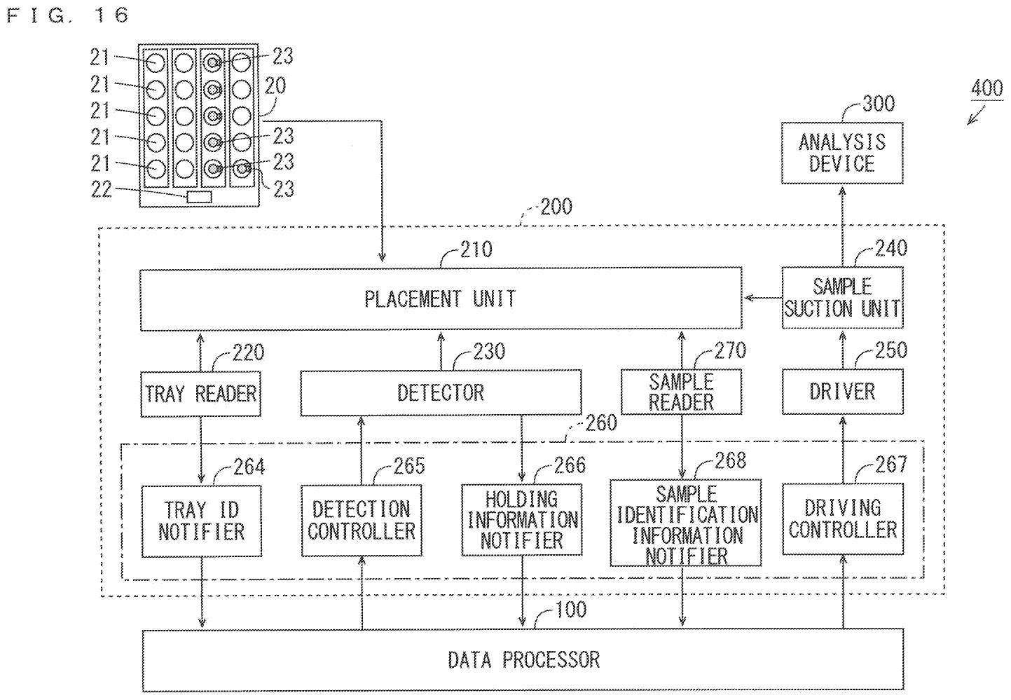

FIG. 15 is a flow chart showing one example of the algorithm of the data process executed by the data processing program. One example of the data process will be described below with reference to the data processor 100 of FIG. 5 and the flow chart of FIG. 15.

As shown in FIG. 15, the pre-registration information acquirer 11 acquires the pre-registration information from the storage 140 or a predetermined storage medium (step S11). Next, the tray ID acquirer 12 determines whether having been notified of a tray ID from the automatic sample injector 200 (step S12). In a case where the step S2 of the notification process of FIG. 14 is performed, the tray ID acquirer 12 is notified of the tray ID. In a case where not being notified of the tray ID, the tray ID acquirer 12 proceeds to the step S14. In a case where being notified of the tray ID, the tray ID acquirer 12 acquires the tray ID (step S13) and proceeds to the step S14.

In the step S14, the tray ID acquirer 12 determines whether a tray ID has already been acquired (step S14). In a case where a tray ID has not been acquired, the tray ID acquirer 12 returns to the step S12. The steps S12 to S14 are repeated until a tray ID is acquired.

In a case where a tray ID has already been acquired in the step S14, the holding information acquirer 13 determines whether having been notified of the holding information from the automatic sample injector 200 (step S15). In a case where the step S6 of the notification process of FIG. 14 is performed, the holding information acquirer 13 is notified of the holding information. In a case where not being notified of the holding information, the holding information acquirer 13 returns to the step S12. The steps S12 to S15 are repeated until the holding information acquirer 13 is notified of the holding information. In a case where the tray 20 to be used for analysis is changed, the tray ID acquirer 12 is notified of a new tray ID in the step S12, and the tray ID that is acquired in the step S13 is updated to the new tray ID.

In a case where being notified of the holding information in the step S15, the holding information acquirer 13 acquires the holding information (step S16). Subsequently, the holding information acquirer 13 determines whether having been notified of the holding information of all of the trays 20 placed in the placement unit 210 (step S17). In a case where not having been notified of the holding information of all of the trays 20, the holding information acquirer 13 returns to the step S16. The steps S16, S17 are repeated until the holding information acquirer 13 is notified of the holding information of all of the trays 20.

Thereafter, the analysis information specifier 14 specifies the analysis information corresponding to the tray ID acquired in the step S13 based on the pre-registration information acquired in the step S11 (step S18). The step S18 may be performed at any point in time after the step S13. Next, the batch file creator 15 creates a batch file based on the holding information acquired in the step S16 and the analysis information specified in the step S18 (step S19). The created batch file may be displayed in the display device 160.

Finally, the device controller 16 controls the automatic sample injector 200 or the analysis device 300 based on the batch file created in the step S19, thereby analyzing or preparing a sample (step S20). While the step S20 is performed automatically after the step S19 in the present embodiment, the embodiment is not limited to this. The step S20 does not have to be performed after the step S19.

Alternatively, the step S20 may be performed in response to an instruction provided by the user after the step S19.

(8) Effects

In the present embodiment, the user of the analysis system 400 selects one or more than one sample containers fitted to the desired analysis information as a sample container to be used for analysis, and seals an appropriate sample in the selected sample container according to the analysis information. Thereafter, the user causes any container holder 21 of the tray 20 to hold a sample container, and places the tray 20 in any placement unit 210 of the automatic sample injector 200.

In the automatic sample injector 200 according to the present embodiment, the data processor 100 is notified by the tray ID notifier 264 of the tray ID unique to the tray 20. The data processor 100 is notified by the holding information notifier 266 of the holding information representing whether a sample container is held by each container holder 21 of the tray 20.

In the data processor 100 according to the present embodiment, the pre-registration information representing the correspondence relationship between the analysis information representing the conditions in regards to the analysis or preparation of samples and the tray IDs is acquired by the pre-registration information acquirer 11. The tray ID acquirer 12 acquires the tray IDs from the automatic sample injector 200.

The analysis information corresponding to the tray IDs acquired by the tray ID acquirer 12 is specified by the analysis information specifier 14 based on the pre-registration information acquired by the pre-registration information acquirer 11.

The holding information acquirer 13 acquires the holding information from the automatic sample injector 200. The batch file creator 15 creates the batch file for controlling the sequence of analysis or preparation in regards to the one or plurality of samples held by the tray 20 based on the holding information acquired by the holding information acquirer 13 and the analysis information specified by the analysis information specifier 14.

With this configuration, the batch file is created automatically. Thus, the user is not required to input various information for creating the batch file to the data processor. Therefore, a user's information recognition error or operational error does not occur. Thus, the batch file can be created efficiently and without errors. Further, erroneous analysis caused by a human error is avoided, so that valuable samples and time for analysis are prevented from being wasteful.

(9) Modified Example

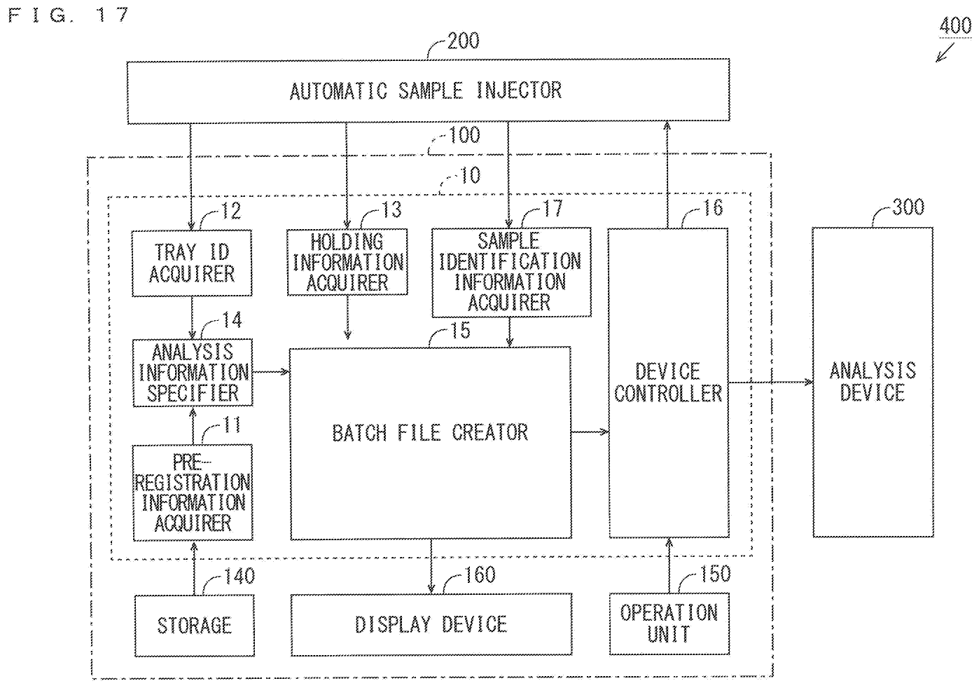

FIG. 16 is a diagram showing the configuration of an automatic sample injector 200 according to a modified example. As shown in FIG. 16, the automatic sample injector 200 according to the modified example further includes a sample reader 270. The sample reader 270 may be an RFID reader, a barcode reader or a QR code reader, for example. Further, the control device 260 further includes a sample identification information notifier 268.

In a sample container storing a sample, a sample identification information display 23 showing the identification information (hereinafter referred to as sample identification information) of the sample is provided. The sample identification information includes an ID (hereinafter referred to as a sample ID) unique to a sample, the name of the sample or the like. The sample identification information display 23 may be an RFID tag, a barcode or a QR code, for example.

When the detector 230 detects whether a sample container is held by each container holder 21 of the tray 20, the sample reader 270 reads the sample identification information from the sample identification information display 23 of the held sample container. The sample identification information notifier 268 notifies the data processor 100 of the sample identification information read by the sample reader 270.

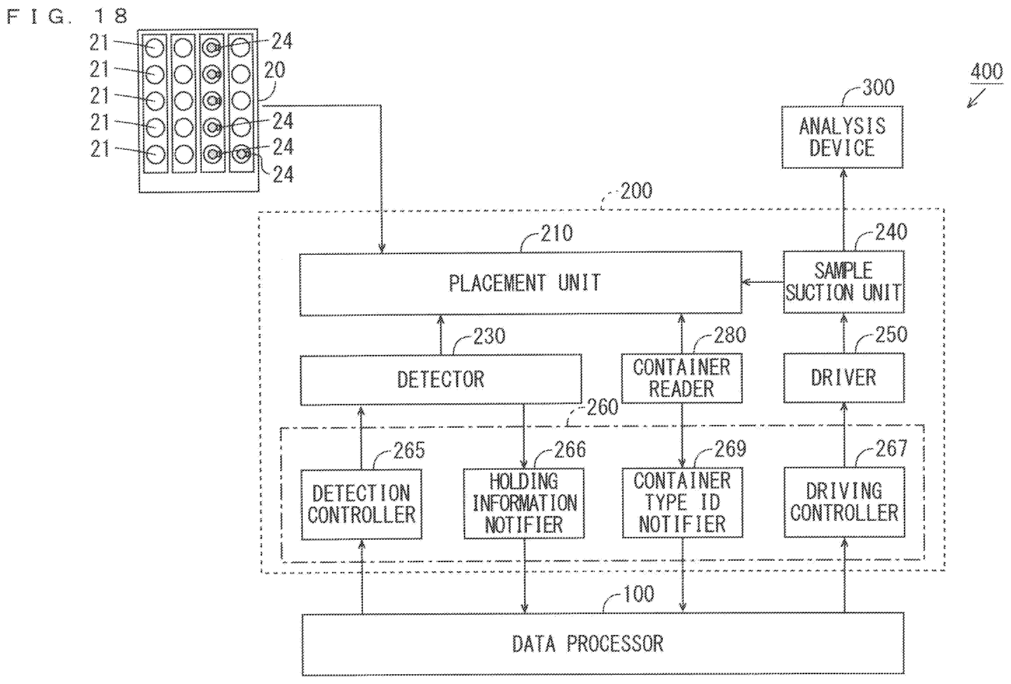

FIG. 17 is a diagram showing the configuration of the data processor 100 according to the modified example. As shown in FIG. 17, the data processor 100 according to the modified example further includes a sample identification information acquirer 17 as a function 10. The sample identification information acquirer 17 acquires the sample identification information from the automatic sample injector 200. The batch file creator 15 creates a batch file further based on the sample identification information acquired by the sample identification information acquirer 17.

In the modified example, the batch file including the sample identification information is created automatically, so that the user is not required to input the sample identification information to the data processor 100. Therefore, the batch file including the sample identification information can be created efficiently and without errors.

Further, the user is not required to hold the sample identification information in regards to the sample to be analyzed separately, so that the sample to be analyzed can be more easily managed.

### 2 Second Embodiment

(1) Configuration of Analysis System

As for a data processor 100 and an automatic sample injector 200 according to a second embodiment, the differences from the data processor 100 and the automatic sample injector 200 according to the first embodiment will be described. In the present embodiment, each sample container is provided with an ID (hereinafter referred to as a container type ID) unique to the type of a container. The pre-registration information represents the correspondence relationship between the analysis information and the container type ID of each sample container.

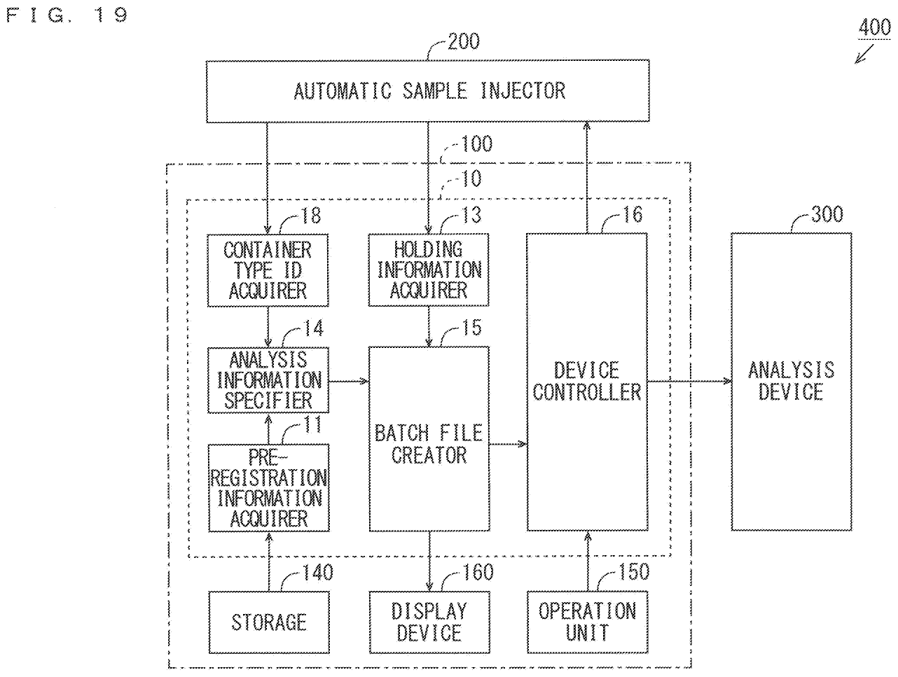

FIG. 18 is a diagram showing the configuration of the automatic sample injector 200 according to the second embodiment. As shown in FIG. 18, the automatic sample injector 200 according to the present embodiment includes a container reader 280 instead of the tray reader 220. Similarly to the sample reader 270 of FIG. 16, the container reader 280 may be an RFID reader, a barcode reader or a QR code reader, for example. Further, the control device 260 further includes a container type ID notifier 269 instead of the tray ID notifier 264.

A container type ID display 24 showing a container type ID is provided to the sample container storing a sample. The container type ID display 24 may be an RFID tag, a barcode or a QR code, for example. When a detector 230 detects whether a sample container is held by each container holder 21 of the tray 20, the container reader 280 reads the container type ID from the container type ID display 24 of a held sample container. The container type ID notifier 269 notifies the data processor 100 of the container type ID read by the container reader 280.

FIG. 19 is a diagram showing the configuration of the data processor 100 according to the second embodiment. As shown in FIG. 19, the data processor 100 according to the present embodiment includes a container type ID acquirer 18 instead of the tray ID acquirer 12 as a function 10. The container type ID acquirer 18 acquires a container type ID from the automatic sample injector 200.

An analysis information specifier 14 specifies the analysis information corresponding to the container type ID acquired by the container type ID acquirer 18 based on the pre-registration information acquired by the pre-registration information acquirer 11. The batch file creator 15 creates a batch file for controlling the sequence of analysis or preparation of the samples stored in all of the held sample containers based on the holding information acquired by a holding information acquirer 13 and the analysis information specified by the container type ID acquirer 18.

(2) Effects

In the present embodiment, a user of an analysis system 400 selects one or more than one sample containers fitted to the desired analysis information as a sample container to be used for analysis, and seals an appropriate sample in the selected sample container according to the analysis information. Thereafter, the user causes any container holder 21 of the tray 20 to hold a sample container and places the tray 20 in any placement unit 210 of the automatic sample injector 200.

In the automatic sample injector 200 according to the present embodiment, a holding information notifier 266 notifies the data processor 100 of the holding information representing whether a sample container is held by each container holder of the tray 20. A container type ID notifier 269 notifies the data processor 100 of the container type ID unique to the type of the one or plurality of held sample containers.

In the data processor 100 according to the present embodiment, the pre-registration information representing the correspondence relationship between the analysis information representing the conditions in regards to the analysis or preparation of samples and the container type IDs is acquired by the pre-registration information acquirer 11. The container type IDs are acquired by the container type ID acquirer 18 from the automatic sample injector 200. The analysis information corresponding to the container type ID acquired by the container type ID acquirer 18 is specified by the analysis information specifier 14 based on the pre-registration information acquired by the pre-registration information acquirer 11.

The holding information is acquired by the holding information acquirer 13 from the automatic sample injector 200. The batch file for controlling the sequence of analysis or preparation in regards to the samples stored in the one or plurality of held sample containers is created by the batch file creator 15 based on the holding information acquired by the holding information acquirer 13 and the analysis information specified by the analysis information specifier 14.

With this configuration, the batch file is created automatically. Therefore, the user is not required to input various information for creating the batch file to the data processor. Thus, a user's information recognition error or operational error does not occur. Thus, the batch file can be created efficiently and without errors.

The container type ID display 24 may further show the sample identification information similar to that of the modified example of the first embodiment. Further, the control device 260 may include the sample identification information notifier 268 similar to that of the modified example, and the data processor 100 may include a sample identification information acquirer 17 similar to that of the modified example. In this case, the container reader 280 may be able to read the sample identification information together with the container type IDs from the container type ID display 24, or a sample reader 270 may be provided in the automatic sample injector 200 separately.

With this configuration, the batch file including the sample identification information is created automatically similarly to the above-mentioned modified example. Thus, the user is not required to input the sample identification information to the data processor 100. Therefore, the batch file including the sample identification information can be created efficiently and without errors. Further, the user is not required to separately hold the sample identification information in regards to the sample to be analyzed, thereby being able to manage the sample to be analyzed more easily.

### 3 Other Embodiments

(1) While the tray 20 is replaceably placed in the placement unit 210 in the above-mentioned embodiment, the embodiment is not limited to this. The tray 20 may be fixedly installed in the placement unit 210. In this case, the tray ID of the tray 20 to be installed in each placement unit 210 is known, so that the automatic sample injector 200 does not have to include the tray reader 220.

(2) In the above-mentioned embodiment, the usage of each tray 20 may be predetermined such that a sample container is held only by a predetermined container holder 21 of each tray 20. In this case, whether a sample container is held by each container holder 21 of each tray 20 is known, so that the automatic sample injector 200 does not have to include the detector 230 or the detection controller 265.

(3) While the automatic sample injector 200 includes the plurality of placement units 210 in the above-mentioned embodiment, the embodiment is not limited to this. The automatic sample injector 200 may include only one placement unit 210.

(4) While the data processor 100 and the automatic sample injector 200 are provided separately in the above-mentioned embodiment, the embodiment is not limited to this. The data processor 100 and the automatic sample injector 200 may be provided integrally. In this case, the CPU 110 and the CPU 261 may be constituted by a common CPU, the RAM 120 and the RAM 262 may be constituted by a common RAM, and the ROM 130 and the ROM 263 may be constituted by a common ROM.

(5) While a tray 20 includes a container holder 21 that holds a sample via a sample container in the first embodiment, the embodiment is not limited to this. The tray 20 may include a sample holder such as a well that directly holds the sample without a sample container. In this case, in the modified example, a sample identification information display 23 may be provided in the vicinity of the sample holder to correspond to the sample.

### 4 Aspects

(Item 1)

A chromatograph data processor that is connected to an automatic sample injector that can introduce a sample held by any one of a plurality of sample holders of a tray into a chromatograph, may include:

a pre-registration information acquirer that acquires pre-registration information representing a correspondence relationship between analysis information representing a condition in regards to analysis or preparation of the sample and a tray ID (identifier) unique to the tray;

a tray ID acquirer that acquires a tray ID from the automatic sample injector;

an analysis information specifier that specifies analysis information corresponding to the tray ID acquired by the tray ID acquirer based on the pre-registration information acquired by the pre-registration information acquirer;

a holding information acquirer that acquires holding information representing whether a sample is held by each sample holder of the tray from the automatic sample injector; and

a batch file creator that creates a batch file for controlling a sequence of analysis or preparation in regards to one or a plurality of samples held by the tray based on the holding information acquired by the holding information acquirer and the analysis information specified by the analysis information specifier.

In this chromatograph data processor, the pre-registration information representing the correspondence relationship between the analysis information representing the conditions in regards to analysis or preparation of samples and a tray ID unique to a tray is acquired by the pre-registration information acquirer. The tray ID is acquired by the tray ID acquirer from the automatic sample injector. The analysis information corresponding to the tray ID acquired by the tray ID acquirer is specified by the analysis information specifier based on the pre-registration information acquired by the pre-registration information acquirer.

The holding information representing whether a sample is held by each sample holder of the tray is acquired by the holding information acquirer from the automatic sample injector. The batch file for controlling the sequence of analysis or preparation in regards to the one or plurality of samples held in the tray is created by the batch file creator based on the holding information acquired by the holding information acquirer and the analysis information specified by the analysis information specifier.

With this configuration, the batch file is created automatically. Therefore, the user is not required to operate to input various information for creating the batch file to the data processor. Therefore, a user's information recognition error or operational error does not occur. Thus, the batch file can be created efficiently and without errors.

(Item 2)

A chromatograph data processor connected to an automatic sample injector that can introduce a sample into a chromatograph from a sample container held by any one of a plurality of container holders, may include:

a pre-registration information acquirer that acquires pre-registration information representing a correspondence relationship between analysis information representing a condition in regards to analysis or preparation of the sample and a container type ID (identifier) unique to a type of the sample container;

a container type ID acquirer that acquires a container type ID of each sample container held by any one of the plurality of container holders from the automatic sample injector;

an analysis information specifier that specifies analysis information corresponding to a container type ID of each sample container based on pre-registration information acquired by the pre-registration information acquirer, the container type ID being acquired by the container type ID acquirer;

a holding information acquirer that acquires holding information representing whether a sample container is held by each container holder from the automatic sample injector; and

a batch file creator that creates a batch file for controlling a sequence of analysis or preparation of a sample stored in one or a plurality of held sample containers based on the holding information acquired by the holding information acquirer and the analysis information specified by the analysis information specifier.

In this chromatograph data processor, the pre-registration information representing the correspondence relationship between the analysis information representing the conditions in regards to analysis or preparation of the sample and the container type ID unique to the type of the sample container is acquired by the pre-registration information acquirer. The container type ID is acquired by the container type ID acquirer from the automatic sample injector. The analysis information corresponding to the container type ID acquired by the container type ID acquirer is specified by the analysis information specifier based on the pre-registration information acquired by the pre-registration information acquirer.

The holding information representing whether the sample is held by each sample holder is acquired by the holding information acquirer from the automatic sample injector. The batch file for controlling the sequence of analysis or preparation in regards to the sample stored in the one or plurality of held sample containers is created by the batch file creator based on the holding information acquired by the holding information acquirer and the analysis information specified by the analysis information specifier.

With this configuration, the batch file is created automatically. Therefore, the user is not required to operate to input various information for creating the batch file to the data processor. Therefore, a user's information recognition error or operational error does not occur. Thus, the batch file can be created efficiently and without errors.

(Item 3)

The chromatograph data processor according to item 1 or 2, may further include a sample identification information acquirer that acquires sample identification information for identifying the sample, wherein

the batch file creator may create a batch file such that the batch file further includes the sample identification information acquired by the sample identification information acquirer.

In this case, because the batch file including the sample identification information is created automatically, the user is not required to input the sample identification information to the data processor. Therefore, the batch file including the sample identification information can be created efficiently and without errors. Further, the user is not required to separately hold the sample identification information in regards to the sample to be analyzed, thereby being able to manage the sample to be analyzed more easily.

(Item 4)

The chromatograph data processor according to any one of items 1 to 3, may further include a device controller that controls the automatic sample injector or the chromatograph such that the sample is analyzed or prepared based on the batch file created by the batch file creator.

In this case, the analysis result or preparation result of the sample can be acquired easily.

(Item 5)

An automatic sample injector that is connected to a chromatograph data processor and can introduce a sample held by any one of a plurality of sample holders of a tray into a chromatograph, may include:

a tray ID notifier that notifies the chromatograph data processor of a tray ID (identifier) unique to the tray; and

a holding information notifier that notifies the chromatograph data processor of holding information representing whether a sample is held by each sample holder of the tray.

In this automatic sample injector, the tray ID notifier notifies the chromatograph data processor of the tray ID unique to the tray. The holding information notifier notifies the chromatograph data processor of the holding information representing whether the sample is held by each sample holder of the tray.

This facilitates automatic creation of the batch file based on the tray ID and the holding information in the chromatograph data processor. Thus, the batch file can be created efficiently and without errors.

(Item 6)

The automatic sample injector according to item 5, may further include:

a placement unit in which the tray is replaceably placed; and

a tray reader that reads a tray ID of the tray placed in the placement unit, wherein

the tray ID notifier may notify the chromatograph data processor of the tray ID read by the tray reader.

In this case, the tray placed in the placement unit is changed, so that the analysis information for creating the batch file can be flexibly changed. Therefore, the user can easily create the batch file corresponding to the desired analysis information by placing the tray corresponding to the desired analysis information in the placement unit.

(Item 7)

The automatic sample injector according to item 5 or 6, may further include a detector that detects whether a sample is held by each sample holder, wherein the holding information notifier may notify the chromatograph data processor of a result of detection by the detector as holding information.

In this case, the chromatograph data processor can be notified of the holding information easily without restriction on the usage of each sample holder of the tray.

(Item 8)

An automatic sample injector that is connected to a chromatograph data processor and can introduce a sample into a chromatograph from a sample container held by any one of a plurality of container holders, may include:

a holding information notifier that notifies the chromatograph data processor of holding information representing whether a sample container is held by each container holder, and

a container type ID notifier that notifies the chromatograph data processor of a container type ID (identifier) unique to a type of one or a plurality of held sample containers.

In this automatic sample injector, the holding information notifier notifies the chromatograph data processor of the holding information representing whether the sample container is held by each container holder. The container type ID notifier notifies the chromatograph data processor of the container type ID unique to the type of the one or plurality of held sample containers.

This facilitates automatic creation of the batch file based on the holding information and the container type ID in the chromatograph data processor. Thus, the batch file can be created efficiently and without errors.

(Item 9)

The automatic sample injector according to item 8, further include a container reader that reads the container type ID of the one or plurality of held sample containers, wherein

the container type ID notifier may notify the chromatograph data processor of the container type ID read by the container reader.

In this case, it is possible to flexibly change the analysis information for creating the batch file by changing the type of the sample container to be used. Therefore, the user can easily create the batch file corresponding to the desired analysis information by causing the sample holder to hold the sample container corresponding to the desired analysis information.

(Item 10)

The automatic sample injector according to item 8 or 9 may further include a detector that detects whether a sample container is held by each container holder, wherein

the holding information notifier may notify the chromatograph data processor of a result of detection by the detector as the holding information.

In this case, the chromatograph data processor can be easily notified of the holding information without restriction on the usage of the container holder.

(Item 11)

The automatic sample injector according to any one of items 5 to 10, may further include:

a sample reader that reads sample identification information for identifying the sample; and

a sample identification information notifier that notifies the chromatograph data processor of the sample identification information read by the sample reader.

This facilitates the automatic creation of the batch file including the sample identification information in the chromatograph data processor. Thus, the batch file including the sample identification information can be created efficiently and without errors. Further, the user is not required to separately hold the sample identification information in regards to the sample to be analyzed, thereby being able to manage the sample to be analyzed more easily.

I/We claim:

1. A chromatograph data processor that is connected to an automatic sample injector that can introduce a sample held by any one of a plurality of sample holders of a tray into a chromatograph, comprising:
a pre-registration information acquirer that acquires pre-registration information representing a correspondence relationship between analysis information representing a condition in regards to analysis or preparation of the sample and a tray ID (identifier) unique to the tray;
a tray ID acquirer that acquires a tray ID from the automatic sample injector;
an analysis information specifier that specifies analysis information corresponding to the tray ID acquired by the tray ID acquirer based on the pre-registration information acquired by the pre-registration information acquirer;
a holding information acquirer that acquires holding information representing whether a sample is held by each sample holder of the tray from the automatic sample injector; and
a batch file creator that creates a batch file for controlling a sequence of analysis or preparation in regards to one or a plurality of samples held by the tray based on the holding information acquired by the holding information acquirer and the analysis information specified by the analysis information specifier.

2. A chromatograph data processor connected to an automatic sample injector that can introduce a sample into a chromatograph from a sample container held by any one of a plurality of container holders, comprising:
a pre-registration information acquirer that acquires pre-registration information representing a correspondence relationship between analysis information representing a condition in regards to analysis or preparation of the sample and a container type ID (identifier) unique to a type of the sample container;
a container type ID acquirer that acquires a container type ID of each sample container held by any one of the plurality of container holders from the automatic sample injector;
an analysis information specifier that specifies analysis information corresponding to a container type ID of each sample container based on pre-registration information acquired by the pre-registration information acquirer, the container type ID being acquired by the container type ID acquirer;
a holding information acquirer that acquires holding information representing whether a sample container is held by each container holder from the automatic sample injector; and
a batch file creator that creates a batch file for controlling a sequence of analysis or preparation of a sample stored in one or a plurality of held sample containers based on the holding information acquired by the holding information acquirer and the analysis information specified by the analysis information specifier.

3. The chromatograph data processor according to claim 1, further comprising a sample identification information acquirer that acquires sample identification information for identifying the sample, wherein
the batch file creator creates a batch file such that the batch file further includes the sample identification information acquired by the sample identification information acquirer.

4. The chromatograph data processor according to claim 1, further comprising a device controller that controls the automatic sample injector or the chromatograph such that the sample is analyzed or prepared based on the batch file created by the batch file creator.

5. An automatic sample injector that is connected to a chromatograph data processor and can introduce a sample held by any one of a plurality of sample holders of a tray into a chromatograph, comprising:
a tray ID notifier that notifies the chromatograph data processor of a tray ID (identifier) unique to the tray; and
a holding information notifier that notifies the chromatograph data processor of holding information representing whether a sample is held by each sample holder of the tray.

6. The automatic sample injector according to claim 5, further comprising:
a placement unit in which the tray is replaceably placed; and
a tray reader that reads a tray ID of the tray placed in the placement unit, wherein
the tray ID notifier notifies the chromatograph data processor of the tray ID read by the tray reader.

7. The automatic sample injector according to claim 5, further comprising a detector that detects whether a sample is held by each sample holder, wherein
the holding information notifier notifies the chromatograph data processor of a result of detection by the detector as holding information.

8. An automatic sample injector that is connected to a chromatograph data processor and can introduce a sample into a chromatograph from a sample container held by any one of a plurality of container holders, comprising:
a holding information notifier that notifies the chromatograph data processor of holding information representing whether a sample container is held by each container holder, and
a container type ID notifier that notifies the chromatograph data processor of a container type ID (identifier) unique to a type of one or a plurality of held sample containers.

9. The automatic sample injector according to claim 8, further comprising a container reader that reads the container type ID of the one or plurality of held sample containers, wherein
the container type ID notifier notifies the chromatograph data processor of the container type ID read by the container reader.

10. The automatic sample injector according to claim 8, further comprising a detector that detects whether a sample container is held by each container holder, wherein
the holding information notifier notifies the chromatograph data processor of a result of detection by the detector as the holding information.

11. The automatic sample injector according to claim 5, further comprising:
a sample reader that reads sample identification information for identifying the sample; and
a sample identification information notifier that notifies the chromatograph data processor of the sample identification information read by the sample reader.

12. The automatic sample injector according to claim 8, further comprising:
a sample reader that reads sample identification information for identifying the sample; and
a sample identification information notifier that notifies the chromatograph data processor of the sample identification information read by the sample reader.
